(19) United States
(12) Patent Application Publication
(10) Pub. No.: US 2010/0122629 A1
(43) Pub. Date: May 20, 2010

(54) Triboelectric air purifier

(76) Inventor: Jacob Fraden, San Diego, CA (US)

Correspondence Address: Jacob Fraden;Kaz, Inc., Ste. 130, 6215 Ferris Sq., San Diego, CA, 92121, US

(21) Appl. No.: 12/589,557

(22) Filed: Oct. 26, 2009

Related U.S. Application Data
(60) Provisional application No. 61/199,440, filed on Nov. 18, 2008.

(51) Int. Cl. B03C 3/30; B03C 3/04; B03C 3/74

(52) U.S. Cl. 96/17; 96/63; 96/51; 96/28

(57) ABSTRACT

Air purifier containing an air blower and a rotating brush, such brush having long flexible bristles made of a material that is capable of developing negative triboelectric charge. During a part of the rotation cycle, the bristles move across a surface that can accumulate a positive charge. This cause the bristle to charge negatively. The air impurities are attracted to negatively charged bristles and discharged into a collecting bin.

### CROSS-REFERENCE TO RELATE APPLICATION

This application claims the benefit under 35 U.S.C. § 119(e) of U.S. Provisional Patent Application No. 61/199,440, filed on Nov. 18, 2008, which is hereby incorporated by reference herein in its entirety.

### FIELD OF THE INVENTION

The present invention relates generally to devices for filtering air and specifically to electrostatic air filters.

### DESCRIPTION OF PRIOR ART

In the foregoing disclosure, terms air filter, air purifier and air cleaner have the same meaning and are used interchangeably.

Nearly all residential dwellings and industrial facilities as well as automobiles and other vehicles incorporate some kind of an air supply or air treatment system. These systems range from a simple ventilation duct to complex automatic air conditioning installations that may include the heating, cooling and humidity control devices. Most of them use air filters to purify air. Many air suction devices, such as vacuum cleaners, also use air filters to separate air gases from airborne soiling particles.

A typical air filter consists of a supporting frame and a filtering mesh, often fabricated of paper, metal or polymer fibers. Clearances in the filter surface and body define the smallest size of the captured particles. Thus, for capturing small particles the filter should be rather dense which results in reduced air flow, requires more powerful blower and increases noise. This type of an air filter is exemplified by the U.S. Pat. No. 5,423,903 issued to Schmitz et al. which is incorporated by reference herein in its entirety.

Other air filters, a passive type, rely on the electrostatic charge acquired by moving soiling particles and thus being attracted to the oppositely charged filter fibers. These filters typically comprise a polymer material as exemplified by the U.S. Pat. No. 3,680,287 issued to Wood et al. which is incorporated by reference herein in its entirety. Passive electrostatic filters have low efficiency due to a substation air flow resistance.

Other electrostatic filters are of an active type as they contain high-voltage power supply and at least two electrically charged metal plates as exemplified by the U.S. Pat. No. 3,763,633 issued to Soltis and U.S. Pat. No. 5,846,302 issued to Putro which are incorporated by reference herein in their entireties. Other electrostatic filters use air ionizers as exemplified by U.S. Pat. No. 4,344,776 issued to Yavnieli which is incorporated by reference herein in its entirety. A substantial drawback of the active electrostatic filters is the need for a high-voltage generator that add cost. Besides, high voltage potentially may pose danger to the user and may result in generation of harmful ozone.

Thus it's a goal of this invention to provide an air filter that may capture various sizes of airborne particles.

Another goal of this invention is to provide air filter having a low air flow resistance;

And another goal of this invention is to provide an air purifier that is easy to clean and would require less frequent change of the filtrating parts.

Still another goal of the invention is to provide an air filter that is low cost and easy to fabricate. Other goals of the invention will become apparent from the following description.

### SUMMARY OF INVENTION

The invention is based on generating high voltage by using a triboelectric effect. The high voltage electric charges are generated on the surfaces of polymer bristles of a rotating brush that touches the inner wall of the filter. The blower moves air near the rotating brush. Most of the airborne particles that are naturally charged positively are being attracted to the negatively charged bristles. A grounded grid discharges and cleans the bristles while collecting dirt in a bin.

### BRIEF DESCRIPTION OF DRAWINGS

FIG. 1 is a cross-sectional view of the air cleaner with a rotating brush.

FIG. 2 shows a discharge grid

FIG. 3 depicts a collection bin with a scrapper

FIG. 4 Illustrates a dual chamber air purifier

FIG. 5 shows the second chamber with ribs

FIG. 6 is a single-chamber air purifier with scrapping ribs

FIG. 7 illustrates a dust collecting bin with an air outlet and conventional filter.

FIG. 8 shows the plate that causes development of negative charges on the bristles.

### DETAILED DESCRIPTION

Many airborne soiling particles naturally carry a positive charge. Examples of the particles are microscopic scales of human skin, animal fur, wool, human hair, and dirt. The present invention is based on use of an electrically attractive force to capture the naturally charged soiling particles to the electrically non-conductive fibers that are charged negatively. The negative charge is generated by a well known triboelectric effect when the fibers are rubbed against a surface and then separated.

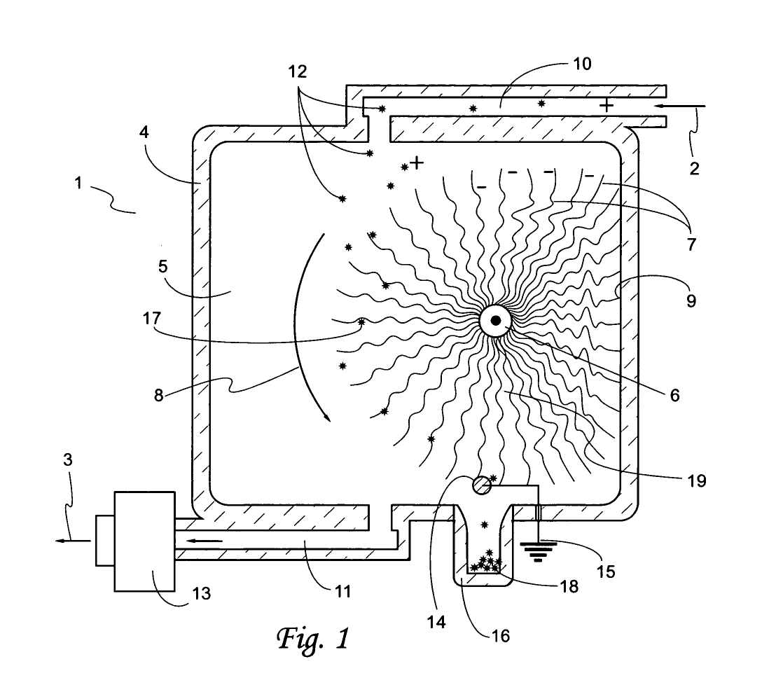

FIG. 1 illustrated a cross-sectional view of the air filtering device 1 (a single-chamber air purifier). It is built inside enclosure 4 having the inner wall 9 that can be made of the same or different material as the body of the enclosure 4. The inner space 5 of the enclosure 4 contains a cylindrical brush 19 that can rotate around axis 6. The brush 19 is composed of a multitude of thin long bristles 7 carried by the axis 6. The brush 19 can rotate in direction 8 either freely (passively) or forcibly by an external rotating mechanism, such as an electric motor. While rotating, the bristles periodically brush against the inner wall 9 of the enclosure 4. In other words, the bristles contact the inner wall 9 only during the first phase of a rotating cycle. For example, the bristles may touch the walls 9 when the brush rotates from 0° to 180° (1^{st} phase of rotation) and not touch the wall while moving from 180° to 360° (2^{nd} phase of rotation). The 1^{st} phase is for generating a negative charge on the bristles, while the 2^{nd} phase is for purifying air. The bristles movement across the wall 9 causes friction that results in a charge separation. Thus, by a suitable selection of materials for the inner wall 9 of enclosure 4 and bristles 7, the bristles become negatively charged when they are separated from the wall 9 in process of moving from 1^{st} phase to 2^{nd} phase during rotation. The bristles should be fabricated of a material that due to a triboelectric effect can develop a strong negative charge. Preferred materials for the bristles are fluoropolymer resins (Teflon), silicon, vinyl and polypropylene. However, other materials can be used as well albeit with a lesser efficiency. The bristle profile may be round or flat, but en effort should be made to maximize the surface area of a bristle. The round bristles should have a diameter on the order of 0.001″ and be pliant and flexible. While the inner walls 9 may be triboelectrically neutral (not to generate a charge), for a better efficiency it is desirable for the walls 9 to develop a positive charge. Thus, preferred materials for the inner walls 9 are glass, quartz, and nylon. Aluminum while still useful is less desirable as it develops a rather week positive charge.

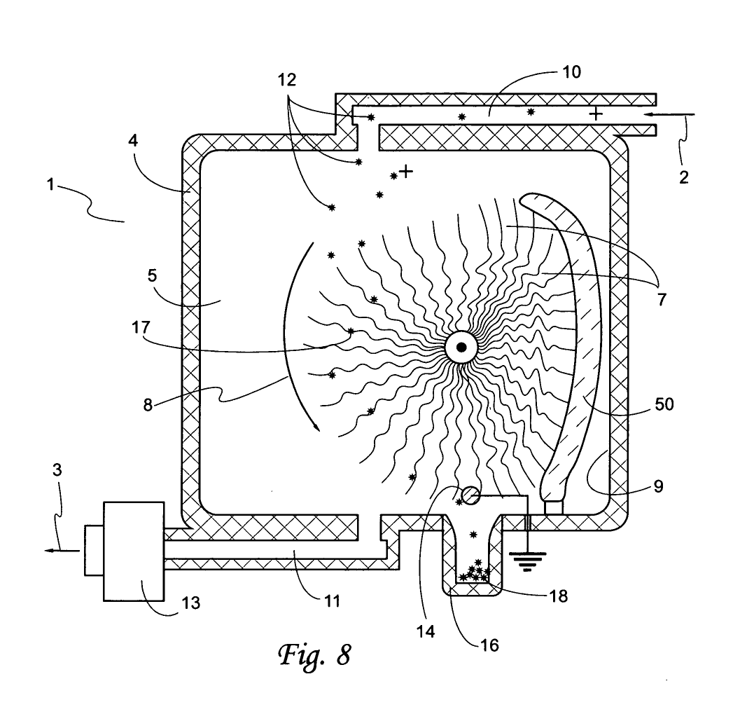

The charge separation function not necessary should be carried out by brush 19 moving at the wall 9. The same effect can be achieved by brush 19 moving bristles against the plate 50 that is positioned inside enclosure 4 and separated from the inner wall 9, as shown in FIG. 8. In this embodiment, the plate should be fabricated from the same materials as listed above for the inner wall 9, while the inner wall 9 material becomes no longer critical and can be made of any metal or resin.

The enclosure 4 has two air ducts: at least one inlet 10 and at least one outlet 11. Dirty air 2 enters the inlet 10 and then moves into the inner space 5, passing by and through the rotating brush 19. It encounters little flow resistance. Dirty air carries the soiling particles 12 that are naturally positively charged. Since air moves near bristles 7 that now are charged negatively thanks to they brushing against the inner wall 9 (or plate 50), particles 12 are being attracted to the bristles 7 thus becoming the attached particles 17. They are carried by the bristles in the direction 8. In the process of rotation within the 1^{st} phase, before moving to the inner wall 9 (or plate 50) the bristles pass by and brush against a discharge finger 14 that is grounded or connected to the enclosure 4. Soiling particles are removed from the bristles and drop into a collecting bin 16 that collects sludge 18.

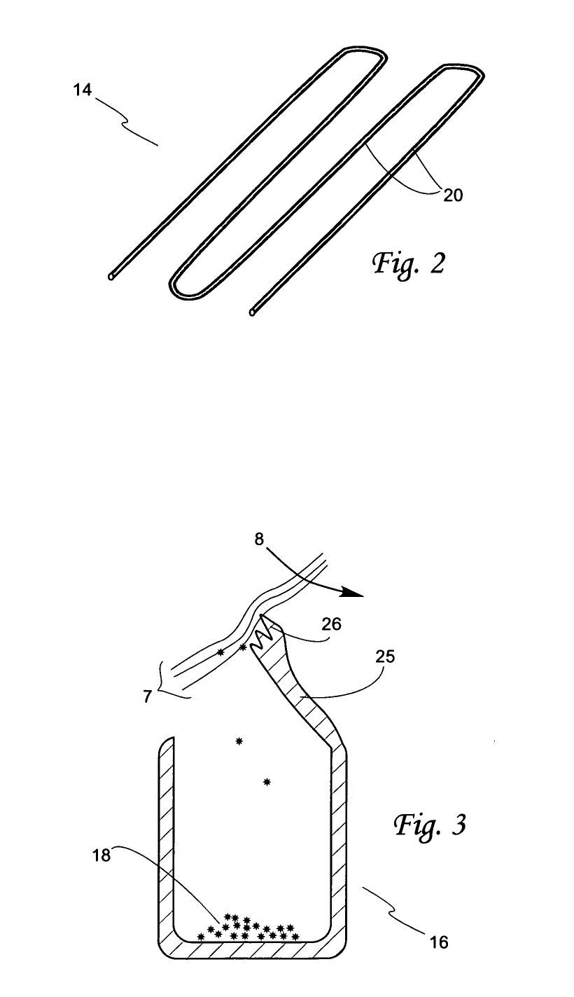

The discharge finger 14 is preferably made of metal (aluminum, e.g.) and may be formed as serially connected rods 20 (FIG. 2). If the inner wall 9 is made of metal (aluminum, e.g.), the discharge grid should be electrically connected to it. If the wall 9 is electrically insulating, the finger 14 preferably should be grounded as shown in FIG. 1 by ground 15.

Air is moved through inlet 10, the inner space 5 and outlet 11 by means of a forced convection caused by the air blower 13 that discharges clean air 3 into the environment or other space where clean air is utilized. If the brush 19 is freely and passively rotating, air moving through the inner space 5 will cause the brush rotation in direction 8. If the brush 19 is forcibly rotating, it may be driven by a separate or the same motor that is part of the blower 13. The bin 16 may be removable for cleaning. Note that the bin 16 and grid 15 may be combined in one device as shown in FIG. 3. Here bin 16 comprises scrapper 25 with fingers 26 that brush against the bristles 7 moving in direction 8. As a result of the mechanical action and discharge, soiling particles are collected at the bottom as sludge 18.

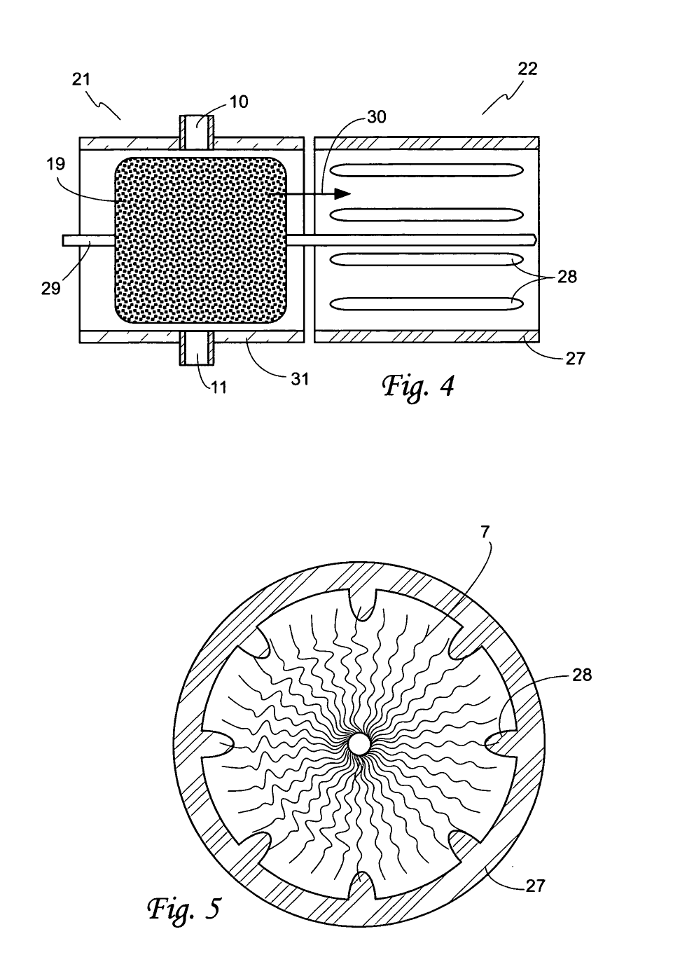

Another method of removing dirty particles from the brush 19 is shown in FIG. 4. There are two adjacent sections 21 and 22. The first section 21 is comprised of enclosure 31 made of the first material (glass, e.g.). The second section which is the chamber 22 contains housing 27 made of the second material (polypropylene, e.g.). The first and second materials should be different in the sign of the generated triboelectric charge. In other words, for best performance polarities of the triboelectric charges for the first and second materials should be opposite. Preferably, the second material should be selected from the same group as the bristles 7.

The brush 19 spins around axis 29 and also on demand can move along the axis 29 from the enclosure 31 to the chamber 22 and back. The device operation consists of two operational phases: the phase P—purification and the phase C being brush self-cleaning. When air is purified (phase P) in the first section 21, it enters via inlet 10 and exits via outlet 11 while the spinning brush 19 is positioned inside the enclosure 31. In the phase C, the brush shifts for self-cleaning to chamber 22, where it also spins. The second chamber may contain elongated ribs 28 (see also FIG. 5) which brush against bristles 7 while the brush 19 rotates. There is no or little charge differential between the bristles and chamber 22. Dirt is dislodged from the bristles and collected between the ribs. Periodically, chamber 22 may be removed and cleaned. It also may be made disposable. After the phase C, the brush 19 moves back to the first chamber 21 for the next phase P to purify air.

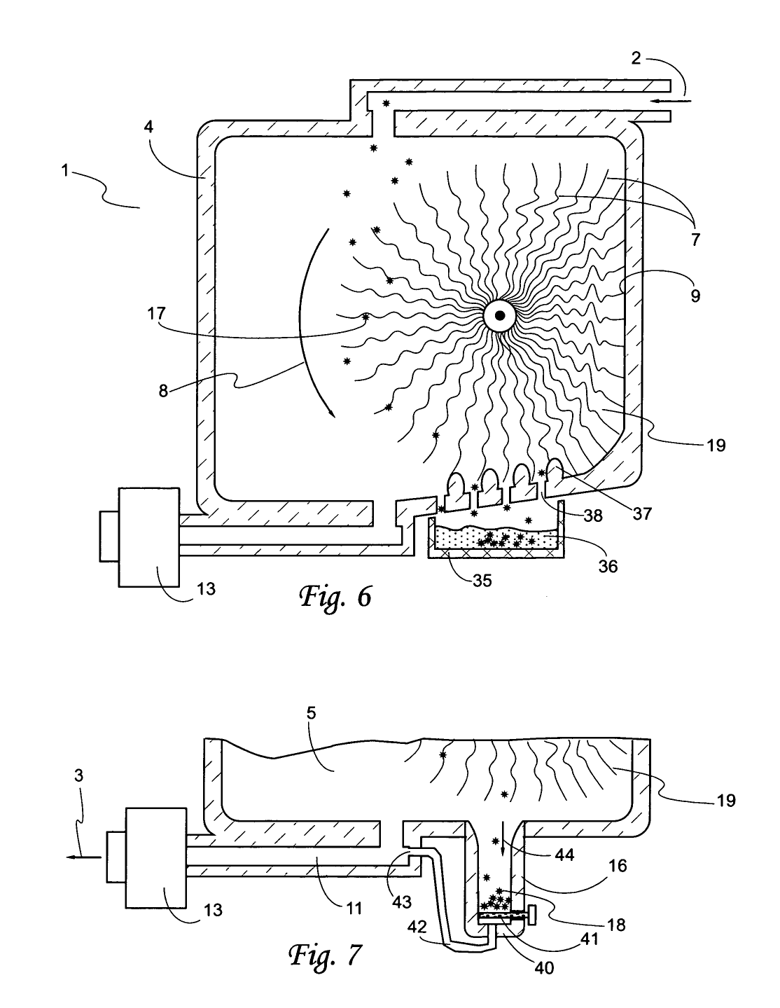

Another version of a single-chamber air purifier is shown in FIG. 6. It contains a collecting bin 35 placed beneath the enclosure 4. The enclosure 4 contains at least one elongated rib 37 with the channels 38 positioned at or in-between the ribs 37. Soiling particles 17 that were attracted to the bristles 7 are now dislodged by the ribs 37 and fall through the channels 38 into the collecting bin 35. To retain dirt inside the collecting bin 35, the bin may be partially filled with water 36. Some disinfecting or cleaning additives may be added to water. Periodically, dirty water should be discarded and the bin 35 refilled with clean water.

FIG. 7 illustrates a further improvement of the collecting bin 16 which is supplied with a conventional air filter 41 and a suction tube 42. The tube 42 is connected to the exhaust outlet 11 at opening 43. The suction tube 42 is a pneumatic connection between the bin 16 and outlet 11. Air pressure at the opening 43 is negative with respect to chamber 5 thanks to operation of blower 13. This pulls dirt in direction 44 toward the filter 41 that collects sludge 18. Filter 41 can be periodically removed and cleaned or replaced.

While the invention has been particularly shown and described with reference to a number of preferred embodiments thereof, it will be understood by those skilled in the art that various changes in form and details may be made therein without departing from the spirit and scope of the invention. Accordingly, the invention is to be limited only by the scope of the claims and their equivalents.

1. Air purifier for removing contaminants from air, comprising a blower and enclosure having an inner wall, an inlet and outlet, further comprising
an axis positioned inside the enclosure;
a brush having first side and second side and being disposed inside said enclosure and capable of rotation around the axis;
a plate being adjacent to the first side of the brush and not adjacent to the second side of the brush, and
bristles attached to the brush, protruding radially from said axis;

2. Air purifier of claim 1 wherein said rotation has the first phase and the second phase wherein the bristles come in contact with the plate during the first phase and not touch the wall during the second phase.

3. Air purifier of claim 1 wherein the bristles are made of a material that develops negative triboelectric charges.

4. Air purifier of claim 1 wherein said plate is made of a material capable of developing positive triboelectric charges.

5. Air purifier of claim 1 further comprising a collection bin being removably attached to said enclosure.

6. Air purifier of claim 1 further comprising at least one discharge finger positioned in close proximity with the outlet.

7. Air purifier of claim 6 wherein said finger is made of metal.

8. Air purifier of claim 1 where the rotation is caused by action of said blower.

9. Air purifier of claim 5 wherein the collection bin is pneumatically connected to said outlet.

10. Air purifier of claim 1 wherein the plate is being a part of said inner wall.

11. Air purifier of claim 1 further comprising a cleaning chamber having the inner wall composed of the second material and being adjacent to said enclosure and having an opening for a periodic relocation of said brush between the enclosure and the chamber, wherein said chamber is capable of collecting contaminants from the brush.

12. Air purifier of claim 11 wherein said second material is capable of generating negative triboelectric charges.

13. Air cleaning device for removing contaminants from air, comprising a source of air pressure, the bristles being part of a brush and a plate, wherein
said bristles are capable of a periodic and alternating brushing against the plate and decoupling from the plate, and
the source of air pressure enables movement of air across said bristles.

14. Air cleaning device of claim 13 further comprising a collection bin being proximally positioned to said brush.

15. Air cleaning device of claim 13 further comprising a finger for removing contaminants from said bristle, such finger being positioned adjacent to said plate is a manner enabling the bristles to come in contact with the finger before the bristles come in contact with the plate.
